(19) United States
(12) Patent Application Publication
(10) Pub. No.: US 2023/0122613 A1
(43) Pub. Date: Apr. 20, 2023

(54) APPARATUS AND METHOD OF REMOTE SENSING

(71) Applicant: Pulsar Process Measurement Limited, Worcestershire (GB)

(72) Inventors: Stephen BALL, Worcestershire (GB); Andrew FOO, Worcestershire (GB); Georgina PERKINS, Worcestershire (GB)

(21) Appl. No.: 17/969,939

(22) Filed: Oct. 20, 2022

(30) Foreign Application Priority Data
Oct. 20, 2021 (GB) GB2115039.6

(51) Int. Cl. F16L 55/48; G01F 15/063

(52) U.S. Cl. CPC F16L 55/48; G01F 15/063; F16L 2101/30

(57) ABSTRACT

A system for the detection of a rate of flow or a level of a fluid or the presence of an object, such as a PIG, in pipelines, comprising at least one detection device that includes: a sensor assembly arranged to detect the rate of flow or level of a fluid withing a section of a pipeline or the presence of a pig located along the section of pipeline where the device is located, a power store, a position determining module, a radio frequency receiver, and a radio frequency transmitter, in which the detection device has a sleep mode in which the sensor assembly is inactive and has a first power consumption and an active mode in which the sensor assembly is active and the detection device has a second, higher, power consumption when the sensor assembly of the device is actively detecting, the device in the active mode also being arranged to transmit signals from the transmitter that are indicative of the detected property of the fluid or presence of an apparatus along the section of the pipeline; and in which the device is configured to switch between the sleep mode and the active mode in response to radio frequency signals received by the receiver.

### CROSS REFERENCE TO RELATED APPLICATIONS

This application claims benefit of pending patent application no. UK application GB2115039.6, filed Oct. 20, 2021, the contents of which are incorporated herein by reference.

### FIELD OF THE INVENTION

This invention relates to an apparatus for remote sensing and in particular for detecting the location of a pig in a section of pipe and a method for the optimal power management of such apparatus.

### BACKGROUND OF THE INVENTION

In large scale fluid distribution systems, process inspection gauges (PIGs), commonly called simply pigs, are regularly used to clean and inspect the pipes that the oil flows through. A PIG is a typically a cylindrical device that goes inside a pipe. It is typically made of foam, polyurethane or steel. The outer diameter of the cylinder will be a close fit with the internal cylindrical wall of the pipe. Normally, when a section of pipe needs inspecting or cleaning, a user goes to the start of the location, where a device known as a PIG launcher sends the PIG through the pip at speed and under pressure. The PIG is removed from the pipeline when it reaches the receiver at the end of the pipeline. Non-intrusive sensors can be manually clamped onto the pipes to help detect where the PIG is—this monitors the status of the run but most importantly can help to locate the position of an immobilized pig.

Typically, sensors are fitted onto the outside of the pipe at several predefined intervals, and as the pig passed through, each sensor will detect and indicate that the pig has passed by the sensor.

### SUMMARY OF THE INVENTION

There are two different technologies for detecting the location of the pig and that can be categorized broadly as active or passive detection technologies. In a passive system the sensor will only listen for the pig acoustic or vibrational signature as it passes. In another variation of the passive system, the pig may carry a beacon and the pig detection device may detect the beacon on the pig. In an active system, the pig has no emitter and is detected using, for example, ultrasound transmission from the sensor.

In both active and passive systems, the pig detection system may include intrusive or non-intrusive sensors. Intrusive sensors require open access to the inside of the pipe. Intrusive sensors either project physically into the pipe or project signals directly into the pipe. Non-intrusive sensors are capable of seeing into the pipe through the pipe wall. Many of the prior systems require a supply of local mains power to the sensors, which for a long pipe line may be impractical.

A modern system will be capable of transmitting measurements to a remote control station, either along physical wires or wirelessly. Some systems even use mechanical sensors—e.g. a flag that is triggered and can be visually inspected by an operator driving along the pipeline when looking for a pig.

The applicant has appreciated that there is a need to provide an improved pig position detection system which can be installed almost anywhere that a pipe is located and which may if desired by left in situ for the lifetime of the pipe network in which it is installed.

In addition to detecting the presence of a PIG in a pipeline there are also many applications where it is desirable to perform non-continuous fluid level sensing or flow sensing within pipelines, Similar apparatus can be used to that discussed above for detecting PIGS with a relatively small change made to the type of detector used to see within the pipeline. The present application applies to those systems in addition to detecting PIGS. In the rest of this document the term fluid is used to cover any material that can flow along a pipe, such as a gas or liquid or any mix of gas, liquid and solid that is able to flow.

According to a first aspect the invention provides a system for the detection of a rate of flow or a level of a fluid or the presence of an apparatus, such as a PIG, in pipelines, comprising at least one detection device that includes:

a sensor assembly arranged to detect the rate of flow or level of a fluid withing a section of a pipeline or the presence of a pig located along the section of pipeline where the device is located,

a power store,

a positioning determining module,

a radio frequency receiver, and

a radio frequency transmitter

in which the detection device has a sleep mode in which the sensor assembly is inactive and the detection device has a first power consumption and an active mode in which the sensor assembly is active and the detection device has a second, higher, power consumption when the sensor assembly of the device is actively detecting,

the device in the active mode also being arranged to transmit signals from the transmitter that are indicative of the detected property of the fluid or presence of an apparatus along the section of the pipeline;

and in which the device is configured to switch between the sleep mode and the active mode in response to radio frequency signals received by the receiver.

For convenience, reference will be made to the use case of detecting the position of a pig in the pipeline in the following passages, but the skilled person will understand that these optional method steps and features apply equally to detectors that sense the level of fluid, or flow rate of fluid or other bulk media within the section of pipeline.

During sleep mode, the sensor assembly may be completely unpowered, for example by deactivating any power supply to the sensor assembly or isolating the sensor assembly from the power source. The sensor assembly could be activated by the remote controller, switching the device into active mode in response to received signals.

In addition to putting the sensor assembly into an inactive state during sleep mode, the device may be configured to place the transmitter also into an inactive state during sleep mode so that it is not transmitting. This may include stopping any oscillator or other drive circuitry for the transmitter when in the sleep mode.

Power consumption may be further reduced in the sleep mode by only providing power to parts of the radio frequency transceiver that maintain minimum and intermittent exchanges with the remote controller.

Additionally, power from the power source may be intermittently withdrawn from all parts of the system as instructed by the remote controller. This reduces the overall power consumption and enables multiple devices to be fitted over a distributed area and left in situ.

By way of example, the attached power store may be rechargeable battery or set of batteries having an energy storage capacity rated to provide sufficient power to operate the device in both the sleep mode and active mode. Semiconductor switches may be provided that enable the on-demand switching of power supply from the battery to the sensor assembly, and independently to the radio frequency transmitter and receiver.

The attached power store may be topped up by means of charging from an external source. This may include, but not limited to, energy generated from a solar panel or a thermal energy generation device.

Each detection device of the system may include an area of electronic memory, and a processor which processes instructions stored in the memory. When executed on the processor the instructions may cause the processor to process signals received from the receiver, transmit pig position signals as required and to operate the sensor assembly.

The processor may in response to signals received at the receiver switch the pig detection device between sleep and active modes.

The processor may comprise a single processing unit which is continuously active or two or more processing units with one continuously active and the other being switched off in the sleep mode. The transmitter/Receiver may for example have a dedicated processor and the sensor assembly may also have its own processing unit.

The processor may receive signals from the receiver that correspond to signals transmitted from a nearby pig detection device, and retransmit those signals onwards using the transmitter. This allows information of pig detection to be relayed across the network of sensors along the pipe. The remote controller may be located at any point along the pipe. The sensors effectively form a network where each sensor only needs to relay information to the adjacent sensor until it arrives at the controller, thus reducing power consumption.

The processor may comprise a digital signal processor configured to filter signals output from the sensor assembly, and to process these signals to identify different types of pig or other apparats. By way of example, the sensing device may be sensitive to acoustic signals and an acoustic signal arriving at the receiver of the sensor may be digitally sampled to form a digital output signal for the sensing device. The time-domain amplitude of the output signal in the time domain may be analyzed for the purpose of positive detection of a PIG or other apparatus in the pipe, whilst the frequency-domain spectrum of the sampled signal may be analysed for Doppler information to detect the movement of a passing pig or other apparatus. Different types of pig or other apparatus may present as a unique set of characteristics in both the amplitude and frequency domain that form a signature that could be identified during signal processing.

The pig detection device may be permanently secured to a pipe or may be attached using a releasable and reusable fixing such as a clamp.

Where the detection device is battery powered and responds to remote signals it may be installed during manufacture of a pipe either prior to delivery to site or onsite. Once installed it would require no manual intervention throughout its operational lifetime.

The detection device may comprise a housing which contains a sensor assembly, transmitter and receiver and the processor may be located inside the housing. This housing may be sealed to prevent the ingress of dirt and moisture and to withstand other environmental hazards such as UV radiation.

When in the active mode, the sensor assembly may switch to sensing mode to use any available passive or active measurement technique to detect a pig or to detect a level of flow of a fluid in the pipe.

In a most preferred arrangement of the passive measurement technique, the sensor assembly may comprise a wideband acoustic receiver, which looks for the acoustic signature associated with the presence of a moving pig. No signals are emitted by the sensor. In a variation of the passive measurement technique, a signal transmitter is integrated to the pig so the passive sensor would detect the signal from the pig as it passes.

In another most preferred arrangement of the active measurement technique, the sensor assembly may comprise an ultrasonic sensor. Ultrasonic pulses are emitted by the sensor transmitter into the pipe and the presence of a pig would cause a change in the signal reflected and received at the sensor receiver. The ultrasonic sensor may also transmit a continuous ultrasonic signal into the pipe and the received signal is analysed for Doppler shift to detect the movement and velocity of the pig. In a variation of the active measurement technique, a reflector may be integrated to the pig to increase signal echo.

When in the active mode the processor may take periodic readings from the sensor assembly and when in the sleep mode no readings may be taken by the sensor. Power may be completely withdrawn from the sensor assembly during sleep mode.

The processor may be configured to cause a radio signal to be transmitted following a switch to active mode. The transmission of this signal is received by the remote controller as confirmation that the device has switched into active mode.

A complete system may comprise a plurality of detection devices according to the first aspect. These may be spaced apart along a section of pipe.

The installations can be spaced from a few centimetres to as far as a few kilometres apart. The spacing may depend on the length of pipe section under inspection.

The system may include a control unit located remotely. This may be in a distant location where the central control unit may switch the device between sleep and active modes.

The central control unit may comprise a computer, such as a laptop computer, which runs the appropriate software. The control unit should include a radio transceiver for communication via RF signals to the devices or have access to a network that offers radio communication connectivity.

When a pig is detected, the position of the pig is also reported to the remote controller using a position signal output from the position determining module.

The position information output by the position determining module could indicate an absolute position, such as a signal obtained by processing signals from a satellite navigations system, for example GPS or GLONASS, or may be a position relative to other sensors in the network.

Additionally, the position determining module attached to the sensor could be activated to determine the geographical coordinates of the detection and this information subsequently transmitted to the remote controller.

Alternatively, the position determining module may include an inertial position measurement device whereby the position is determined by a process of dead reckoning. The later will allow it to function in regions where not satellite signal is available.

In another alternative, the position of the device may be semi-permanently stored in the position determining module in an area of memory, for example by an operator who is fitting the device at a known location.

The radio communication network may also be in the form of terrestrial cellular network. Additionally, this radio communication network may also be in the form of satellite communication network. A communication modem interfaces between the sensor assembly and the radio transceiver. Depending on the type of network available, a suitable modem and radio transceiver would be fitted.

According to a second aspect, the invention provides a detection device in particular for detecting a PIG in a pipeline for use in the system of the first aspect of the invention.

According to a third aspect of the invention, there is provided a method of detecting the position of a pig or the level or flow rate of a fluid within a section of pipeline, the method including: at a detection device of a system according to the first aspect, receiving a signal from an external source at the receiver, decoding the signal to determine if the signal encodes an instruction to send the detection device into an active mode and in that event waking up the device, with a sensor assembly of the detection device detecting the passage of a pig or the level or flow of a fluid, and transmitting a signal from a transmitter of the device indicative of the position of a pig or the level or flow rate of a fluid.

The method may comprise sending a pig along the pipe after wakening the detection device.

The method may comprise, once a pig has been detected and a signal transmitted from the transmitter encoding the detection, automatically placing the pig detection device back into a sleep mode.

The method may comprise receiving signals from the pig detection device at a central control unit and analysing the signals to determine the position of a pig. The signals may be received directly or indirectly.

The method may comprise transmitting a signal to the pig detection device from a central control unit via a satellite.

The method may comprise transmitting a signal from a remote device to a central control unit that includes information from which the device can determine if the signal is associated with that device or with a different device. This may include an identity code which may be associated with the device.

Features described in relation to any of the above aspects of the invention may be applied, mutatis mutandis, to any of the other aspects of the invention.

### BRIEF DESCRIPTION OF THE DRAWINGS

The invention will now be described, by way of example only, with reference to the accompanying drawings, in which:

FIG. 1 schematically illustrates a pig detection device according to an aspect of the invention fixed to a section of pipe;

FIG. 2 schematically illustrates the key function components of the pig detection device of FIG. 1;

FIGS. 3 to 6 show the device of FIGS. 1 and 2 included in a system for monitoring the position of a pig and the steps carried out in a method monitoring position according to an aspect of the invention;

FIG. 7 shows a system according to a first aspect including four pig detection devices; and

FIG. 8 is a schematic of a sensor assembly used in the exemplary pig detection device of FIGS. 1 and 2.

### DETAILED DESCRIPTION OF THE DRAWINGS

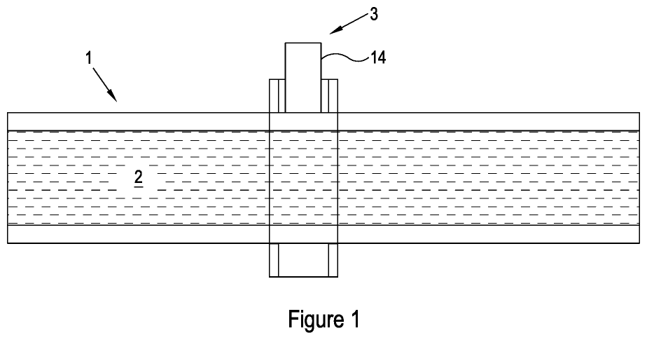

FIG. 1 shows a schematic illustration of a section of pipe 1 carrying a fluid 2, in this example oil, along which a pipe pig (not shown in FIG. 1) can be passed as part of an inspection of the condition of a pipeline or to cleanse the pipe. Located along the pipe is a pig detection device 3.

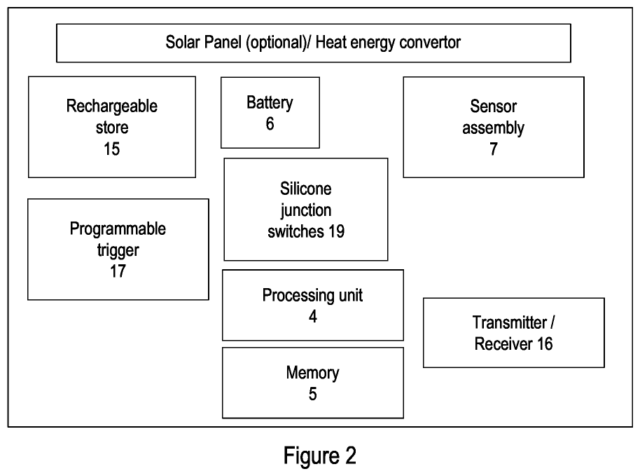

FIG. 2 shows schematically the principal components of the pipe pig detection device 3. The device 3 includes a processing unit 4 which is connected to an area of memory 5. Program instructions stored in the memory 5 are executed by the processing unit to operate the device 3 during use. The processing unit 4 and memory 5 are powered by a battery 6 and a part of the processing unit. During the sleep mode, power is withdrawn from all parts of the sensor assembly. Power may be completely withdrawn from 4, 5, and 7 which can be awaken either by 17 or remotely via 16

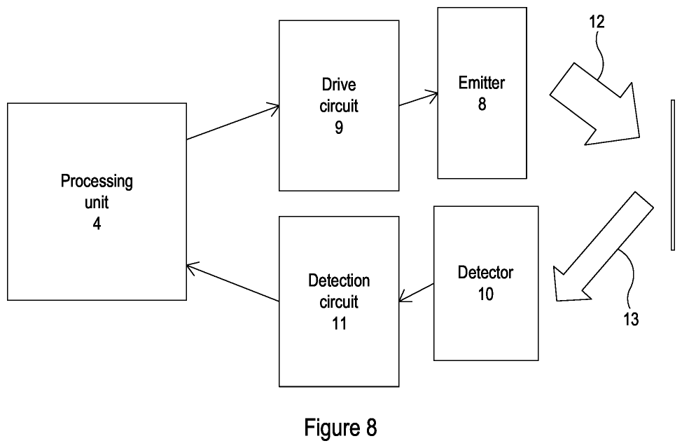

The device 3 includes a sensor assembly 7. As shown in FIG. 8, the sensor assembly 7 used in the exemplary device of FIG. 1 comprises an ultrasonic emitter 8, a drive circuit 9 for the emitter, an ultrasonic detector 10, and a detection circuit 11 from the detector 10. The processing unit 4 in the active mode supplies control signals to the drive circuit 9 and receives signals output from the detector 10.

The emitter 8 is driven to emit a sequence of ultrasonic pulses 12, and the detector measures ultrasonic radiation 13 that is incident on the detector 10 due to reflections of the emitted ultrasonic pulses 12. The emitter 8 and detector 10 are mounted in a housing 14, shown in FIG. 1, which is secured to an outer wall of the pipe, with access to the inside of the pipe 1 through a cut out in the wall of the pipe 1. The emitter 8 is oriented so that ultrasound is emitted across the diameter of the pipe one to the opposing inner wall, and the detector 10 is oriented such that some or all of the radiation reflected from the rear of the pipe will be incident on the detector.

The device 3 includes a battery 6 that stores electrical energy to power the device 3. It also includes an optional rechargeable energy store 15 that receives electrical energy captured by an optional solar panel 16 that is connected to the device. The battery 6 and energy store 15 connect to a supply rail (not shown) on a circuit board (not shown) that supports the processing unit 4 and memory 5 of the device 3.

The pig detection device 3 also includes an RF transceiver 16. This comprises an RF receiver for receiving wireless radiation of a defined range of frequencies and down converting these into a lower frequency electrical signal that is input to the processing unit 4. In this example the RF receiver is responsive to radiation in the frequency band between 1 to 2 GHz, or commonly referred to as the L-Band.

The RF transceiver 16 also includes an RF transmitter. This is configured to emit RF radiation encoding an output signal generated by the processing unit. The RF radiation may be in the same frequency range as the detected RF radiation, but this is not essential to the invention. RF radiation may be emitted in a different range of frequencies. The choice will depend on how the transmitted radiation is to be detected at a centrally located, remote, control unit at a monitoring station. In this example the output signal transmitted includes an identity of the pig detection device and a binary pig position signal, having a first value if no pig has been detected since being put into the active mode and a second value is a pig is detected or has been detected since being put into the active mode. This signal therefore provides an indication that a pig is either upstream or downstream of the device, and therefore provides an indication of the pig position.

The transmitted output signal may be relayed by a satellite to a control unit at a central location which allows an operator to determine the position of a pig along the pipe.

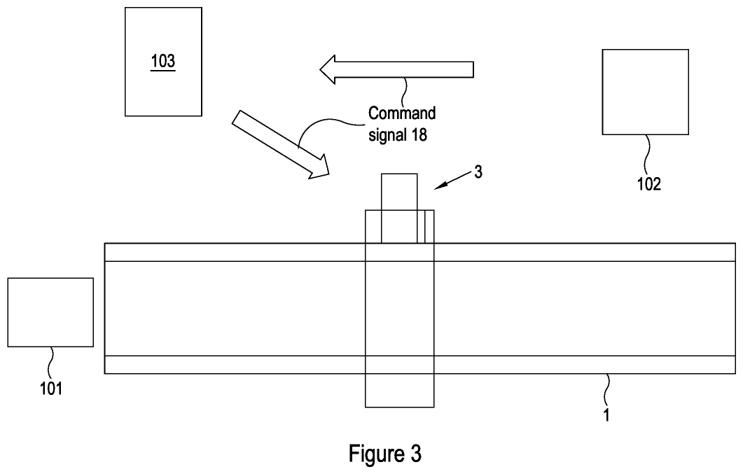

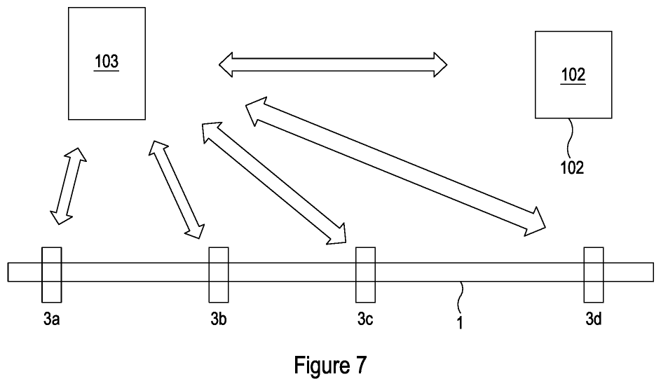

FIGS. 3 to 6 show the use of the pig detection device 3 of FIG. 1 within a system 100 for the detection of the position of a pig 101 in a pipe 1. As shown the system 100 in this simple example comprises one pipe pig detection device 3 secured to a pipe section, and a remote control station 102. In a practical system there may be multiple pig detection devices located at different positions along a section of pipe. FIG. 7 shows the provision of four devices 3a, 3b, 3c, 3d, all controlled from the same remote control station 102, dividing the pipe 1 into five sections. The position of a pig 101 in any of those sections can be determined by interpreting the signals emitted from all four pig detection devices 3a-3d.

Normally the pig detection device 3 will occupy a low power sleep mode. In this mode, the sensor assembly 7 is powered down and does not emit ultrasound. The detection circuit of the sensor assembly may also be inactive in this mode and optionally also the transmitter. By switching off the emitter and sensor in the sleep mode the pig detection device draws a limited amount of power from the battery 6.

When in sleep mode, device 3 will periodically monitor the receiver for an enabling instruction which is received wirelessly at the receiver. The processing unit 4 monitors signals detected by the RF receiver and analyses the content of the signal for a characteristic instruction associated with the pig detection device 3. This may, for example, include the identity code which must match a code stored in the memory 5 of the pig detection device 3. The command signal may also include a command instruction. The command instruction may be a command to wake the device and place it in an active mode or a command to put the device into the sleep mode. If a command signal is detected by the device 3 with the correct ID the device 3 will be brought out of sleep mode by the processing unit 4. Any other received signals will not wake the device 3 or put it to sleep. If a signal is received instructing the device 3 to enter the sleep mode, the device 3 will respond accordingly. These steps are illustrated in FIG. 3 of the drawings, the block arrows showing the command signal being transmitted from a central unit via a satellite 103 to the device.

The device 3 may listen periodically by only intermittently monitoring the receiver, for instance for a few seconds every 5 minutes or perhaps once every hour or once per day or at certain times of the day. The lower the frequency at which listening takes place the lower the power consumption of the device during sleep mode.

Power could be completely withdrawn from 4 and 5 for a pre-determined or programmable interval, such that only a very low power programmable trigger would be used to reactivate 4 and 5 at pre-set intervals or schedule. Supply of power from the battery to the electronic parts within the sensor assembly can be controlled by 4 or 17 via silicone junction switches 19. The programmable trigger 17 may be integrated as a peripheral along with 4 and 5 on modern microprocessors.

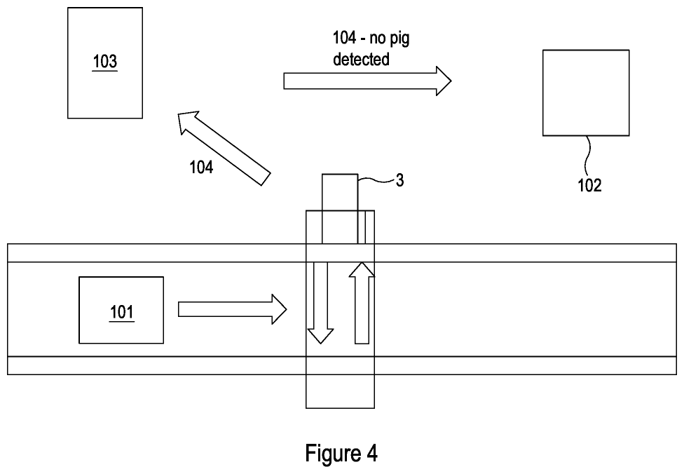

FIG. 4 shows the function of the device 3 when in the active mode. The pig detection device 3 emits ultrasound waves 12 into the pipe and in the absence of a pig 101 in the pipe 1 receives reflections from the opposite face of the pipe 1 which are detected by the detector. When a pig 101 passes through the part of the pipe that receives the ultrasound, the detection device will detect reflections from the pig and not from the opposite side of the pipe. The processing unit 4 of the detection device 3 processes the reflections and, based on the time of flight, determines the distance from the ultrasound emitter to the reflective surface. The different times of flight between a clear pipe and the pipe with a pig enables the presence of the pig to be detected.

As shown in FIG. 4 the operator of the pig 101 will make an opening into one end of the section of pipe and place the pig 101 into position before sealing the pipe again. The pig 101 at this time is stationary because no fluid, such as oil, is flowing in the pipe. An operator at a control station 102 then issues an instruction to wake up the pig detection apparatus located along the section of the pipe 1. This is achieved by transmitting the command signals wirelessly to the pig detection device 3 that includes the appropriate ID codes. These signals are received by the pipe pig detection device and cause it to move from the sleep mode to an active mode.

The now awake and active pig detection device 3 periodically transmits and receive ultrasound into an out of the pipe. In this active mode the device transmits an RF output signal 104 from the transmitter

that is received back at the control station 102. The transmitted signals should initially indicate that no pig has been detected. If the signals from any of the devices at this time are not received, or indicate that a pig has been detected, this will indicate a fault of the device and remedial work may be instigated before activating the pig.

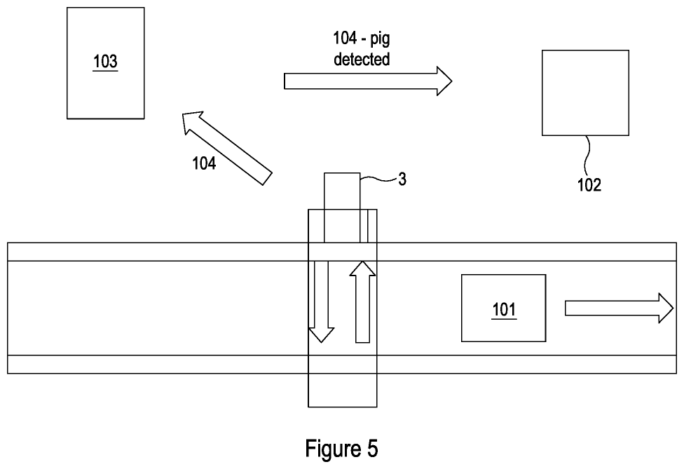

Once all devices are considered to be awake and operating correctly, the operator of the pig will start fluid flow from the end of pipe upstream of the pig. This will cause the pig to move along the pipe due to hydraulic pressure. As the pig moves it will inspect the interior of the pipe. This is illustrated in FIG. 5 which shows the pig 101 just after passing the pig detection device 3.

The pig detection devices 3 continue to monitor for the pig 101, and when the pig 101 is in the vicinity of a device 3 it will be detected by the device due to the change in time of flight of the ultrasonic transmitted-reflected signals. The processor will then change the signal emitted by the transmitter to indicate that a pig has been detected. The signal may retain this state until the device is moved back to the sleep mode. This signal is detected and stored at the central location.

To determine the location of the pig, the operator simply looks at the state of the received output signals 104, with the pig being located downstream of the last pig detection device along a pipe that indicates a pig is present and upstream of the first pig detection device that indicates that no pig has been detected.

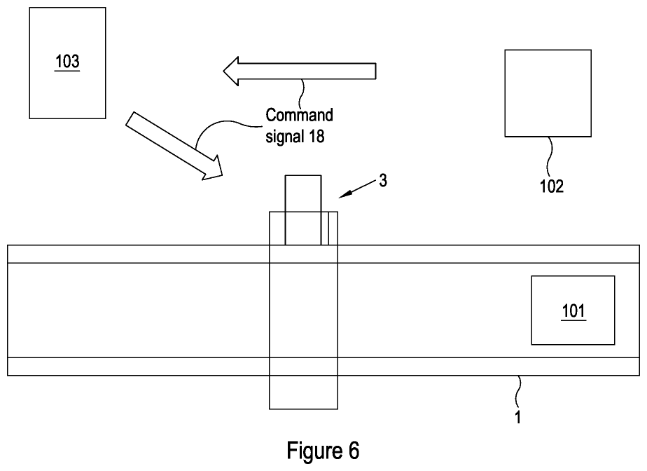

The operator may then stop the flow of fluid once inspection is completed and locate and remove the pig 101 from the section of pipe 1. At this time a signal may be sent to the pig detection device 3 instructing the device 3 to go to sleep and re-enter the sleep mode as the pig run has been completed. This step is shown in FIG. 6.

1. A system for the detection of a rate of flow or a level of a fluid or the presence of an object, such as a PIG, in pipelines, comprising at least one detection device that includes:
a sensor assembly arranged to detect the rate of flow or level of a fluid withing a section of a pipeline or the presence of a pig located along the section of pipeline where the device is located,
a power store,
a position determining module,
a radio frequency receiver, and
a radio frequency transmitter,
in which the detection device has a sleep mode in which the sensor assembly is inactive and has a first power consumption and an active mode in which the sensor assembly is active and the detection device has a second, higher, power consumption when the sensor assembly of the device is actively detecting,
the device in the active mode also being arranged to transmit signals from the transmitter that are indicative of the detected property of the fluid or presence of an apparatus along the section of the pipeline;
and in which the device is configured to switch between the sleep mode and the active mode in response to radio frequency signals received by the receiver.

2. A system according to claim 1 in which during sleep mode the sensor assembly is completely unpowered due to deactivation of the power store supplying power to the sensor assembly or isolating the sensor assembly from the power store.

3. A system according to claim 1 whereby in addition to putting the sensor assembly into an inactive state during sleep mode the device is configured to place the transmitter also into an inactive state during sleep mode so that it is not transmitting.

4. A system according to claim 1 in which the detection device is configured to respond to signals received at the receiver to switch the pig detection device between the sleep mode and active mode.

5. A system according to claim 1 in which the detection device is permanently secured to a pipe or attached using a releasable and reusable fixing.

6. A system according to claim 1 in which the detection device comprises a housing which contains the sensor assembly, transmitter and receiver and a processor.

7. A system according to claim 1 in which the sensor assembly comprises a passive sensor assembly, in particular a wideband acoustic receiver which looks for the acoustic signature associated with the presence of a moving pig.

8. A system according to any one of claim 1 in which the sensor assembly comprises an active sensor assembly, in particular an ultrasonic sensor.

9. A system according to claim 1 in which the detection device configured to cause a radio signal to be transmitted following a switch to active mode. The transmission of this signal is received by the remote controller as confirmation that the device has switched into active mode.

10. A system according to any 1 which comprises two or more detection devices each having the features of any of the preceding claims.

11. A system according to claim 1 further comprising a control unit located remotely from the detection device or detection devices, the control unit being configured to transmit signals to the detection devices that are detected by the receiver of the detection device and prompt the detection device to enter or exit the sleep mode or active mode.

12. A system according to claim 11 in which the central control unit comprises a computer, such as a laptop computer and a radio transceiver for communication via RF signals to the detection device or devices.

13. A system according to claim 1 in which the position information output by the position determining module indicates an absolute position based on information from a global satellite navigation system.

14. A detection device in particular for detecting a PIG in a pipeline for use in the system, as defined in claim 1.

15. A method of detecting the position of a pig or the level or flow rate of a fluid within a section of pipeline, the method including: at a detection device of a system according to the first aspect, receiving a signal from an external source at the receiver, decoding the signal to determine if the signal encodes an instruction to send the detection device into an active mode and in that event waking up the device, with a sensor assembly of the detection device detecting the passage of a pig or the level or flow of a fluid, and transmitting a signal from a transmitter of the device indicative of the position of a pig or the level or flow rate of a fluid.

16. The method of claim 15 further comprising wakening the detection device prior to sending a pig along the pipe.

17. The method of claim 15 further comprising once a pig has been detected and a signal transmitted from the transmitter encoding the detection, automatically placing the pig detection device back into a sleep mode.

18. The method of claim 15 comprising receiving signals from the pig detection device at a central control unit and analysing the signals to determine the position of a pig.

19. The method of claim 18 comprising transmitting a signal from the central control unit to the pig detection device via a satellite that instructs the detection device to enter the sleep mode or enter the active mode.
